(19) United States
(12) Patent Application Publication
(10) Pub. No.: US 2009/0060360 A1
(43) Pub. Date: Mar. 5, 2009

(54) Method and apparatus for processing image and electronic device using the same

(75) Inventors: Ling-Hsiu Huang, Sinshih Township (TW); Shing-Chia Chen, Sinshih Township (TW)

Correspondence Address: RABIN & Berdo, PC, 1101 14TH STREET, NW, SUITE 500, WASHINGTON, DC, 20005, US

(73) Assignee: HIMAX TECHNOLOGIES LIMITED, Tainan County (TW)

(21) Appl. No.: 11/896,546

(22) Filed: Sep. 4, 2007

(51) Int. Cl. G06K 9/36

(52) U.S. Cl. 382/237

(57) ABSTRACT

A method and apparatus for processing an image, and an electronic device are provided. The method comprises: picking a maximum gray level from the gray levels in the sub-pixels of each image pixel in the image to obtain a luminance map which is consisted of the maximum gray levels of the image pixels; determining an image-content lightness of the image according to the luminance map; and adjusting the gray levels in the sub-pixels of the image pixels in the image according to the image-content lightness of the image.

### BACKGROUND OF THE INVENTION

1. Field of the Invention

The invention relates in general to a method and an apparatus for processing an image, and more particularly to a method and an apparatus for processing an image and an electronic device using the same to enhance the luminance of the image

2. Description of the Related Art

Usually, to adjust the luminance of an image, a method based on the YUV model is employed. The YUV model includes three components: Y, U, and V. The Y component represents the luminance and the U and V components represent the chrominance. Each pixel in an image contains the data of gray levels of red, green, and blue colors. Therefore, when adjusting the luminance of an image, it is necessary to convert the data in each pixel of the image from the RGB model to the YUV model in advance. With the image transformation, although data having Y, U, and V components in each pixel is obtained, only the Y component is used in the luminance adjustment. After the Y components of all pixels in the image are adjusted, they are converted back to the gray levels that are based on the RGB model. Subsequently, an adjusted image with a luminance higher than that of the original image can be presented in any display or electronic device.

However, the transformation used in the image luminance adjustment procedure described above requires additional hardware for operation; this results in a higher manufacturing cost. Besides, owing to the hardware limitations of the, truncation errors will occur frequently in transformation procedure, thereby causing unexpected side effects.

### SUMMARY OF THE INVENTION

The invention is directed to a method and an apparatus for processing an image and an electronic device using the same. With the direct conversion of the data of an image that is based on the RGB model, it simplifies the conversion procedure and eliminates the use of additional hardware and is capable of enhancing the luminance of the image.

According to the present invention, a method for processing an image is provided. The method comprises: picking a maximum gray level from the gray levels in the sub-pixels of each image pixel in the image to obtain a luminance map which is consisted of the maximum gray levels of the image pixels; determining an image-content lightness of the image according to the luminance map; and adjusting the gray levels in the sub-pixels of each image pixel in the image according to the image-content lightness of the image.

According to the present invention, an apparatus for processing an image is provided. The apparatus includes a selecting unit, a determining unit and an adjusting unit. The selecting unit is for picking a maximum gray level from the gray levels in the sub-pixels of each image pixel in the image to obtain a luminance map that is consisted of the maximum gray levels of the image pixels in the image. The determining unit is for determining an image-content lightness of the image according to the luminance map. The adjusting unit is for adjusting the gray levels in the sub-pixels of each image pixels in the image according to the image-content lightness of the image.

According to the present invention, an electronic device including a display panel, a backlight, a selecting unit, a determining unit and an adjusting unit is provided. The display panel is for display an image. The backlight is for illuminating the display panel. The selecting unit is for picking a maximum gray level from the gray levels in the sub-pixels of each image pixel in the image to obtain a luminance map that is consisted of the maximum gray levels of the image pixels in the image. The determining unit is for determining an image-content lightness of the image according to the luminance map. The adjusting unit is for adjusting the gray levels in the sub-pixels of each image pixels in the image according to the image-content lightness of the image. When the luminance of the backlight is reduced, the adjusted gray levels in the sub-pixels of each image pixel in the image are higher than the original gray levels for maintaining the lightness of the image.

The invention will become apparent from the following detailed description of the preferred but non-limiting embodiments. The following description is made with reference to the accompanying drawings.

### BRIEF DESCRIPTION OF THE DRAWINGS

FIG. 1 is a flowchart showing the steps of a method for processing an image according to an embodiment of the invention;

FIG. 2 is a block diagram of an apparatus for processing an image according to an embodiment of the invention;

FIG. 3 is a block diagram of an electronic device according to an embodiment of the invention;

FIG. 4 is the image including a plurality of image pixels;

FIG. 5 is a map consisting of the maximum gray levels of each image pixel in the image in FIG. 4;

FIG. 6 is a histogram showing a distribution of the maximum gray levels of the image pixels in the image; and

FIG. 7 is a diagram showing an example of a gain curve for adjusting the gray levels of the sub-pixels in the image pixels.

### DETAILED DESCRIPTION OF THE INVENTION

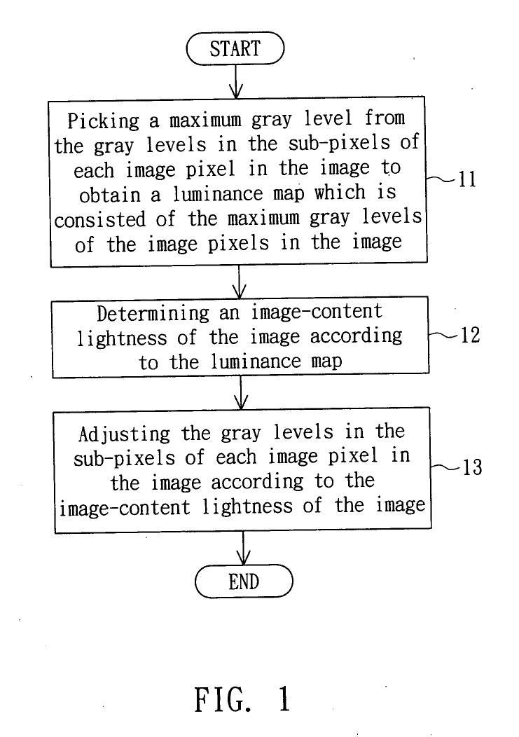

Referring to FIG. 1, a flowchart showing the steps of a method for processing an image according to an embodiment of the invention is provided. As shown in FIG. 1, the method for processing an image includes the steps 11˜13: picking a maximum gray level from the gray levels in the sub-pixels of each image pixel in the image to obtain a luminance map consisting of the maximum gray levels of the image pixels in the image in step 11; determining an image-content lightness of the image according to the luminance map in step 12; and adjusting the gray levels in the sub-pixels of each image pixel in the image according to the image-content lightness of the image in step 13.

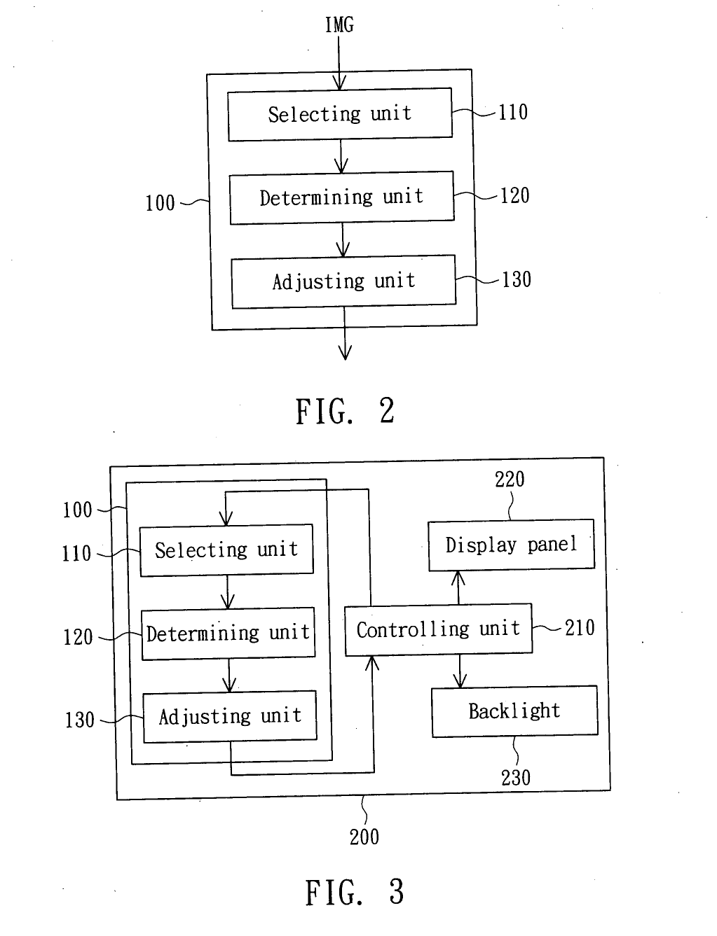

The above method can be applied to an apparatus for processing an image. Referring to FIG. 2, a block diagram of an apparatus for processing an image according to an embodiment of the invention is provided. The apparatus 100 includes a selecting unit 110, a determining unit 120 and an adjusting unit 130. The selecting unit 110 is for picking a maximum gray level from the gray levels GL in the sub-pixels of each image pixel in the image to obtain a luminance map that is consisted of the maximum gray levels of the image pixels in the image. The determining unit 120 is for determining an image-content lightness of the image according to the luminance map. The adjusting unit 130 is for adjusting the gray levels in the sub-pixels of each image pixels in the image according to the image-content lightness of the image. With the help of the apparatus 100, when an image IMG is inputted to the apparatus 100, the gray levels in the sub-pixels of each image pixel in the image are adjusted accordingly.

Besides, the method and apparatus stated above is especially suitable to an electronic device that has a backlight and a display panel. Referring to FIG. 3, a block diagram of an electronic device according to an embodiment of the invention is provided. The electronic device 200 includes a controlling unit 210, a display panel 220, a backlight 230, and the apparatus 100 for processing images. The display panel 220, the backlight 230 and the apparatus 100 are electrically connected to the controlling unit 210.

The backlight 230 of the electronic device 200 is adjustable according to the power amount of the battery in the electronic device 200. Usually, the illumination of the backlight 230 will be reduced when the power amount is low. For reducing the power consumption of the battery, the illumination of the backlight 230 is lowered. Therefore, the lightness of the image displayed in the display panel 220 is lowered with the backlight 230 that has lowered illumination. As a result, the display quality of the image will be largely reduced, and the image cannot be clearly displayed. By using the method indicated in FIG. 1, the apparatus 100 processes the image to enhance the lightness the image, then the problem of bad display quality is avoided. The method for processing the image is elaborated with more detail as below.

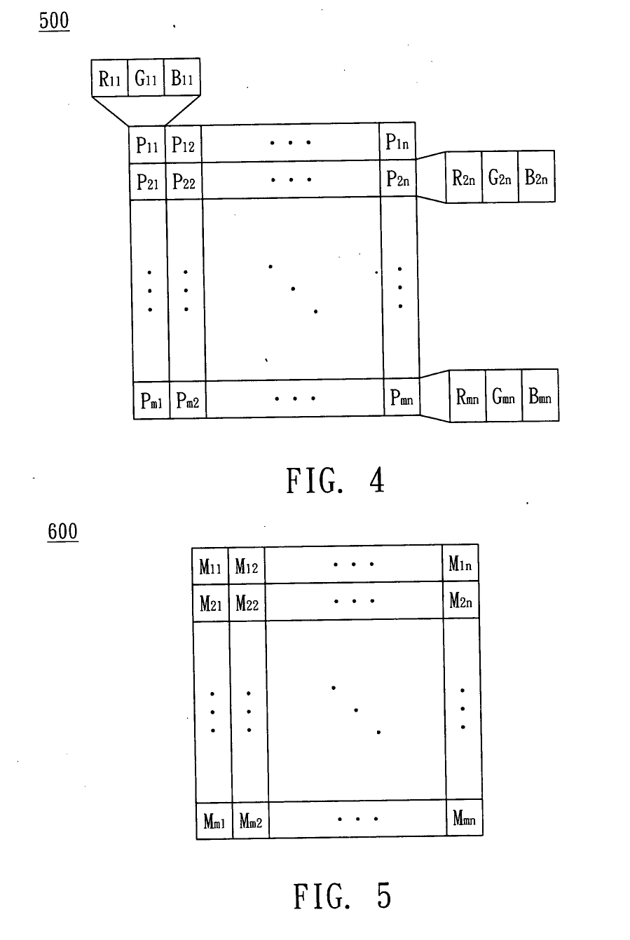

Referring to FIG. 4, the image including a plurality of image pixels is shown. The image 500 includes image pixels Pij (i=1˜m, j=1˜n), and each of the image pixels Pij includes several sub-pixels. In this embodiment, each of the image pixels Pij (i=1˜m, j=1˜n) in the image 500 has three sub-pixels for example. The three sub-pixels have gray levels Rij, Gij, and Bij of red, green, and blue colors, respectively. The gray levels Rij, Gij, and Bij are between 0 and 255, for example. When the processing method starts, as indicated in step 11, the maximum gray level from the gray levels in the three sub-pixels of each image pixels Pij in the image 500 is picked. Each of image pixels Pij has its own maximum gray level Mij equal to Rij, Gij, or Bij.

After the maximum gray level Mij of each of the image pixels Pij is obtained, referring to FIG. 5, a luminance map 600 consisting of the maximum gray levels Mij of all image pixels Pij in the image in FIG. 4 is generated accordingly.

As shown in step 12, determining an image-content lightness of the image according to the luminance map 600. The image-content lightness of the image 500 represents the lightness level of the whole image. When the image 500 has a high image-content lightness, the lightness of the image 500 is high. On the contrary, if the image-content lightness of the image 500 is low, the lightness level of the image 500 is low too.

The image-content lightness of the image 500 can be determined by many methods. For example, the image-content lightness can be an average gray level of the maximum gray levels Mij of the image pixels Pij in the image 500. As the average gray level is high, the image 500 has plenty of image pixels with high gray levels. Therefore, the image 500 has high image-content lightness. If the image 500 has plenty of image pixels with low gray levels, the image 500 has low image-content lightness.

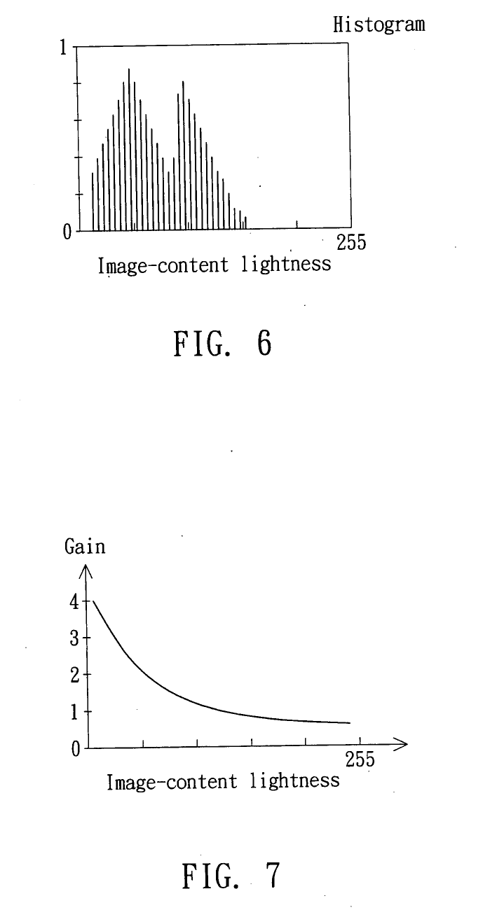

Besides, the image-content lightness of the image 500 can be determined according to the distribution of the maximum gray levels Mij of the image pixels Pij. Referring to FIG. 6, a histogram showing a distribution of the maximum gray levels of the image pixels of the image is provided. The histogram is obtained according to the luminance map 600. The numbers of image pixels Pij of the same maximum gray level Mij from 0 to 255 are obtained and normalized, which are shown in FIG. 6. The histogram clearly shows the distribution of the maximum gray levels Mij in the image pixels Pij of the image 500. According to the information revealed by the histogram, it is possible to obtain the image-content lightness of the image 500 by analyzing the histogram shown in FIG. 6. The image-content lightness can also be determined by applying an algorithm to the maximum gray levels Mij of the luminance map 600. For example, when the amount of the image pixels Pij with high maximum gray levels is much more than the amount of the image pixels Pij with low maximum gray levels in the image 500, the image-content lightness of the image 500 is high. When the amount of the image pixels Pij with low maximum gray levels is much more than the amount of the image pixels Pij with high maximum gray levels in the image 500, the image-content lightness of the image 500 is low.

Thereafter, as indicated in FIG. 1, the step 13 of adjusting the gray levels in the sub-pixels of each image pixel Pij in the image 500 according to the image-content lightness of the image 500 is performed.

As stated before, when the illumination of the backlight 230 is low, the display quality of the image is bad. Therefore, the gray levels of the image 500 can be adjusted when the illumination of the backlight 230 is reduced to maintain the display quality. However, when the image 500 is adjusted, part of the adjusted gray levels of the image pixels Pij may be over 255. The problem happens with high possibility to the image of high image-content lightness. Therefore, when the image 500 has higher image-content lightness, there is no need to adjust the gray levels in the image pixels Pij of the image 500 largely. On the contrary, if the image-content lightness of the image 500 is low, the gray levels of the image pixels Pij in the image 500 can be adjusted largely. Therefore, for different image-content lightness, different gain can be chosen to adjust the image 500.

Referring to FIG. 7, it is a diagram showing an example of a gain curve for adjusting the gray levels of the sub-pixels in image pixels. As indicated in FIG. 7, when the image 500 has higher image-content lightness, the image 500 is adjusted with a smaller gain. When the image has lower image-content lightness, the image 500 is adjusted with a larger gain. The chosen gain based on the image-content lightness is applied to all gray levels in the image pixels Pij of the image 500. For example, the gray levels of the all image pixels in the image are multiplied by the same chosen gain to generate the adjusted gray levels in the sub-pixels of the all image pixels in the image.

The adjusted gray levels in sub-pixels of the image pixels Pij can be greater than the gray levels in the sub-pixels of the image pixels Pij before adjusting in order to enhance the lightness of the image 500, for example, according to the curve shown in FIG. 7 under the situation that the illumination of the backlight is lowered. Besides, the adjusted gray levels in sub-pixels of the image pixels Pij can be smaller than the gray levels in the sub-pixels of the image pixels Pij before adjusting in order to lower the lightness of the image 500 according to another curve with the gain less than 1.

In order to maintain the same display effect of the image 500 when the illumination of the backlight 230 is reduced, the chosen gain is also set according to the illumination decrement of the backlight 230. Preferably, as the adjusted luminance of the backlight 230 is K times the original luminance, the chosen gain is substantially 1/K. For example, when the illumination of the backlight 230 is reduced to a half of the original illumination, the chosen gain for adjusting the gray levels in the sub-pixels of each image pixel Pij in the image 500 can be set as 2. Therefore, the adjusted gray levels in the sub-pixels of each image pixel Pij in the image 500 are adjusted by double, such that the display quality of the image 500 still remains the same.

Although the image 500 is adjusted under the condition that the backlight 230 is reduced to maintain the same display quality of the image 500 in the present embodiment, the invention is not limited thereto. The method in FIG. 1 and apparatus 200 in FIG. 2 are also applied to enhancing or lowering the lightness of an image alone no matter whether the illumination of the backlight 230 is adjusted or not.

It is noted that the adjustment of image pixels Pij in the image 500 is based on the maximum gray levels Mij in the image pixels Pij and the image-content lightness of the image 500. If the maximum gray levels Mij in the image pixels Pij after adjusting the image 500 are smaller than or equal to 255, it ascertains that all gray levels of the image pixels Pij are smaller than 255. Therefore, the amount of adjusted gray levels that exceed 255 by choosing the gain according to all of the maximum gray levels of all image pixels will be less than the amount of adjusted gray levels that exceed 255 by choosing the gain according to the Y (luminance) components of all pixels in the conventional method. Compared with the conventional method based on the YUV model of adjusting the image luminance, the processing method in the embodiment of the invention effectively reduces the probability of the truncation error that causes the image distortion problem. Besides, without the complicated operation of the conventional method that requires additional expensive hardware, the circuit for the invention is not complicated and the cost of the invention is very low. For example, the selecting unit and determining unit can be implemented by comparators while circuits for RGB to YUV transformation and for RGB to YUV transformation are not required.

The method and apparatus for processing the image of the invention are directed to the maximum gray levels in each image pixel of an image, they are particularly suitable for dynamic backlight control (DBLC) in most display devices or electronic devices. In the cooperation with the DBLC, many electronic devices, such as mobile devices or mobile phones, can still maintain the display quality of the image when the backlight illumination is reduced for lowering the power consumption of the battery. The method and apparatus for processing the image of the invention can also be applied without adjusting the illumination of the backlight.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A method for processing an image, comprising:
picking a maximum gray level from the gray levels in the sub-pixels of each image pixel in the image to obtain a luminance map which is consisted of the maximum gray levels of the image pixels in the image;
determining an image-content lightness of the image according to the luminance map; and
adjusting the gray levels in the sub-pixels of each image pixel in the image according to the image-content lightness of the image.

2. The method according to claim 1, wherein the gray levels of the sub-pixels comprise the gray levels of red, green, and blue colors.

3. The method according to claim 1, wherein the step of determining an image-content lightness of the image comprises:
generating the average gray level of the maximum gray levels of the image pixels to obtain the image-content lightness of the image.

4. The method according to claim 1, wherein the step of determining an image-content lightness of the image comprises:
determining the image-content lightness according to the distribution of the maximum gray levels in the image pixels.

5. The method according to claim 1, wherein the adjusted gray levels in the sub-pixels of the image pixels are greater than the gray levels of the sub-pixels of the image pixels before adjusting to enhance the lightness of the image.

6. The method according to claim 1, wherein the adjusted gray levels in the sub-pixels of the image pixels are smaller than the gray levels in the sub-pixels of the image pixels before adjusting to reduce the lightness of the image.

7. The method according to claim 1, wherein the step of adjusting comprises:
determining a gain according to the image-content lightness of the image; and
adjusting all gray levels of the sub-pixels of each image pixel of the image according to the gain.

8. The method according to claim 7, wherein the method is used in an electronic device having a backlight, when the backlight is adjusted, and the adjusted luminance of the backlight is K times the original luminance, the gain is substantially equal to 1/K.

9. An apparatus for processing an image, comprising:
a selecting unit for picking a maximum gray level from the gray levels in the sub-pixels of each image pixel in the image to obtain a luminance map which is consisted of the maximum gray levels of the image pixels in the image;
a determining unit for determining an image-content lightness of the image according to the luminance map; and
an adjusting unit for adjusting the gray levels in the sub-pixels of each image pixels in the image according to the image-content lightness of the image.

10. The apparatus according to claim 9, wherein the gray levels in the sub-pixels comprise the gray levels of red, green, and blue colors.

11. The apparatus according to claim 9, wherein the image-content lightness of the image is the average gray level of the maximum gray levels in the image pixels.

12. The apparatus according to claim 9, wherein the image-content lightness of the image is determined according to the distribution of the maximum gray levels in the image pixels.

13. The apparatus according to claim 9, wherein the adjusted gray levels in the sub-pixels of the image pixels are greater than the gray levels in the sub-pixels of the image pixels before adjusting to enhance the lightness of the image.

14. The apparatus according to claim 9, wherein the adjusted gray levels in the sub-pixels of the image pixels are smaller than the gray levels in the sub-pixels of the image pixels before adjusting to reduce the lightness of the image.

15. The apparatus according to claim 9, wherein the determining unit chooses a gain according to the image-content lightness of the image, and the adjusting unit adjusts all gray levels in the sub-pixels of each image pixel of the image according to the gain.

16. The apparatus according to claim 15, wherein the apparatus is used in an electronic device having a backlight, when the backlight is adjusted, and the adjusted luminance of the backlight is K times the original luminance, the gain is substantially equal to 1/K.

17. An electronic device, comprising:
a display panel for displaying an image;
a backlight for illuminating the display panel;
a selecting unit for picking a maximum gray level from the gray levels in the sub-pixels of each image pixel in the image to obtain a luminance map which is consisted of the maximum gray levels of the image pixels in the image;
a determining unit for determining an image-content lightness of the image according to the luminance map; and
an adjusting unit for adjusting the gray levels in the sub-pixels of each image pixels in the image according to the image-content lightness of the image;
wherein, when the luminance of the backlight is reduced, the adjusted gray levels in the sub-pixels of each image pixel in the image are higher than the original gray levels for maintaining the lightness of the image.

18. The electronic device according to claim 17, wherein the image-content lightness of the image is the average gray level of the maximum gray levels in the image pixels.

19. The electronic device according to claim 17, wherein the image-content lightness of the image is determined according to the distribution of the maximum gray levels in the image pixels.

20. The electronic device according to claim 17, wherein the determining unit chooses a gain according to the image-content lightness of the image, and the adjusting unit adjusts all gray levels in the sub-pixels of each image pixel of the image according to the gain.

21. The electronic device according to claim 20, wherein when the backlight is adjusted, and the adjusted luminance of the backlight is K times the original luminance, the gain is substantially equal to 1/K.
